(19) United States
(12) Patent Application Publication
(10) Pub. No.: US 2020/0085079 A1
(43) Pub. Date: Mar. 19, 2020

(54) COMPOSITION AND METHOD FOR FORMING MULTILAYER EDIBLE PET PRODUCT

(71) Applicant: T.F.H. PUBLICATIONS, INC., Neptune City, NJ (US)

(72) Inventors: Glen S. AXELROD, Colts Neck, NJ (US); Terry WILLIAMS, Brick, NJ (US)

(21) Appl. No.: 16/569,783

(22) Filed: Sep. 13, 2019

Related U.S. Application Data
(60) Provisional application No. 62/731,324, filed on Sep. 14, 2018.

(51) Int. Cl. A23K 10/30; A23K 20/179; A23K 40/20

(52) U.S. Cl. CPC A23K 10/30; A23K 40/20; A23K 20/179

(57) ABSTRACT

Edible pet treat or chew formulations are disclosed. In embodiments, the formulations form, when subject to a single injection molding cycle, a molded product (e.g., a molded pet treat or chew) that includes a core and an outer layer on the core. The outer layer has at least one characteristic that differs from a corresponding characteristic of the core. Methods of forming edible pet treats or chews using such formulations and pet treats or chews formed from such formulations are also described.

### CROSS REFERENCE TO RELATED APPLICATIONS

This application is a non-provisional of and claims priority to U.S. Provisional Application No. 62/731,324, filed Sep. 14, 2018, the entire content of which is incorporated herein by reference.

### FIELD

The present disclosure is directed at a composition and method for forming an edible pet product having a surface with different physical characteristics than the core. The product can be prepared by a single injection molding cycle wherein dissimilar surface characteristics are developed in the mold and based upon the selected formulations and associated injection molding conditions.

### BACKGROUND

The prior art is replete with numerous reports of pet chew formulations, and in particular edible formulations, that are capable of being formed via injection molding protocols. For example, in U.S. Pat. No. 5,827,565, owned by T.F.H. Publications, Inc., there is disclosed a process for making a heat expandable dog chew comprised primarily of injection molding potato starch granules and an attractant.

In U.S. Pat. No. 8,124,156 there is disclosed a method of manufacturing a multi-component pet treat or chew comprising two or more materials which may differ in some physical, optical, nutritional, sensual or compositional property, wherein the multiplicity of material may be formed to lie adjacent one another in layered, surrounding, partially surrounding, abutting or interlocked fashion. In one exemplary embodiment, two or more materials may be injection molded by forming a first shape from the first material in a first mold cavity, followed by moving the first molded shape to a second mold cavity to form the second material adjacent and in contact with at least portion of the first material.

As may therefore be appreciated, it would be highly advantageous to develop a formulation and method, that would provide the ability to form a multilayered pet treat or chew, from a single formulation, where the surface has a different physical, optical, nutritional, sensual or compositional property from the core and in a single injection molding cycle.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 schematically illustrates on example of a molded article formed from an edible pet treat or chew formulation, consistent with the present disclosure; and

FIG. 2 is a flow diagram of example operations of a method of forming a molded article from an edible pet treat or chew formulation consistent with the present disclosure.

### DETAILED DESCRIPTION

The present disclosure generally relates to edible pet treat or chew formulations, molded pet treats or chews formed from such formulations, and methods of forming a pet treat or chew from such formulations. In non-limiting embodiments, the present disclosure relates to an edible pet treat or chew formulations that, upon injection molding, provide a multi-layered pet treat where the layers differ in some physical, optical, nutritional, sensual or compositional property. In further embodiments, the present disclosure relates to methods of forming a pet treat or chew, such as a multiple layer (e.g., two or more layer) pet treat or chew in a single injection molding cycle, wherein the pet treat or chew includes an outer layer disposed on the surface of a core, wherein the outer layer and the core have different corresponding characteristics/properties, such as different corresponding physical, optical, nutritional, sensual or compositional property than the inner core of the molded product. In such context, a difference in a physical property may include a different hardness or tensile strength. A difference in an optical property may be understood herein as a difference in color. A difference in a nutritional property may be understood as a difference in, e.g., vitamin or mineral content, calories, protein level/amount, starch level/amount, etc. A difference in sensual properties may be understood as a difference in attractant level/amount. A difference in compositional properties may be understood as a difference in chemical structure of one or more ingredients relied upon to formulate the treat.

As using herein, the term “corresponding” when used in reference to a first characteristic/property of a first of a pet treat or chew (e.g., an outer layer) means that the first characteristic/property is of the same type (e.g., physical, optical, nutritional, sensual or compositional property), as a second characteristic/property of a second portion of a pet treat or chew (e.g., a core), but does not indicate that the first and second characteristics/properties are identical to one another. For example, an outer layer of a pet chew may have a first color and the core of the pet chew may have a second color. In such instances, the first color and the second color may be referred to as corresponding characteristics/properties in that they are both colors. However, the first color need not be identical to the second color.

Preferably, the edible pet treat or chew formulation herein is one or a mixture of edible components (described more fully herein), along with a selected amount of a vegetable component. When injected into a mold, the edible pet treat or chew formulation (and, more particularly, the vegetable component) exhibits a thermal response that results in the production of a molded product having a core and an outer layer on the core, wherein the outer layer has at least one physical characteristic/property that differs from a corresponding characteristic/property of the core. In particular, the vegetable component in the edible pet treat or chew formulation is selected such that it forms an outer layer on the core, wherein the outer layer exhibits an optical property (e.g. a color) that differs from a corresponding optical property of the core, which is formed from the mixture of edible components.

In embodiments, the vegetable component is preferably in powder form, as a vegetable powder. Non-limiting examples of suitable vegetable powders that may be used as or in the vegetable component include a powder made from any common vegetable, such as but not limited to beets. In embodiments, the vegetable powder is sourced from the beetroot portion of the beet plant. In embodiments, the vegetable component is beet powder, and is present in the edible pet treat or chew formulation in any suitable amount, such as from 0.1% to 15.0% by weight, more preferably from 0.1% to 10.0% by weight, and even more preferably, from 3.0% to 5.0% by weight. Regardless of the type of vegetable powder used, the particle size of the vegetable powder may range from 10 μm to 750 μm. Preferably, the vegetable component is formed from water soluble vegetable powder.

Preferably, the edible pet treat or chew formulation is starch based, meaning that the edible pet treat or chew formulation contains starch in an amount ranging from greater than or equal to 50% by weight. More preferably, starch is present in the edible pet treat or chew formulation in an amount ranging from 50% by weight to 75% by weight, and even more preferably, in an amount ranging from 50% by weight to 60% by weight.

The starch may be sourced from a single source or multiple sources. Non-limiting examples of suitable starches that may be used as or in the edible pet treat or chew formulation include cereal starch, corn starch, potato starch, tapioca starch, components thereof, and the like. In embodiments, the starch is cereal starch, corn starch, potato starch, or tapioca starch.

In embodiments the total weight of the vegetable component and starch equals 100% by weight of the edible pet treat or chew formulation. In other embodiments, the edible pet treat or chew formulation includes the vegetable component, starch, and one or more additives. Non-limiting examples of suitable additives that may be used in the edible pet treat or chew formulation include: glycerin in an amount ranging from 10.0% by weight to 20.0% by weight; gelatin in an amount ranging from 5.0% by weight to 15.0% by weight; a palatability enhancer in an amount ranging from 1.0% by weight to 10.0% by weight; calcium carbonate in an amount ranging from 1.0% by weight to 5.0% by weight; cellulose fiber in an amount ranging from 1.0% by weight to 5.0% by weight; and/or lecithin powder in an amount ranging from 0.1% by weight to 2.5% by weight, wherein the indicated weight percentages are relative to the total weight of the edible pet treat or chew formulation. In embodiments, the edible pet treat or chew formulation includes greater than or equal to 50% by weight of starch, and includes one, a combination of, or all the additives noted above in an amount falling within the above noted ranges,

In embodiments the edible pet treat or chew composition includes: starch in an amount ranging from 50% by weight to 75% by weight (e.g., 50 to 60% by weight), glycerin in an amount ranging from 10.0% by weight to 20.0% by weight of the edible composition; gelatin in an amount ranging from 5.0% by weight to 15.0% by weight; a palatability enhancer in an amount ranging from 1.0% by weight to 10.0% by weight; calcium carbonate in an amount ranging from 1.0% by weight to 5.0% by weight; cellulose fiber in an amount ranging from 1.0% by weight to 5.0% by weight; and lecithin powder in an amount ranging from 0.1% by weight to 2.5% by weight, wherein the indicated weight percentages are relative to the total weight of the edible pet treat or chew formulation. In some embodiments, the total weight of the vegetable component, starch, and additives (glycerin, gelatin, palatability enhancer, calcium carbonate, cellulose fiber, and lecithin powder) equals 100% by weight of the edible pet treat or chew formulation.

In still further embodiments the edible pet treat or chew formulation includes a vegetable component, starch, (optionally) one or more additives noted above, and optionally further includes a meat flavoring (e.g., roast beef flavoring, bacon flavoring, chicken flavoring, etc.) or a combination thereof. In embodiments, the edible pet treat or chew formulation includes the vegetable component, starch, and one or more of the additives noted above (e.g., in the above noted amounts, and further includes meat flavoring (e.g., lamb meal) in an amount ranging from 0.1% by weight to 5.0% by weight; roast beef flavor at a level of 0.1% by weight to 5.0% by weight, bacon flavor at a level of 0.1% by weight to 5.0% by weight; chicken flavoring at a level of 0.1% by weight to 5.0% by weight, wherein the indicated weight percentages are relative to the total weight of the edible pet treat or chew formulation, and the total amount of the vegetable component, starch, additives (if any), meat flavoring, roast beef flavoring, bacon flavoring, and chicken flavoring equals 100 weight % of the edible pet treat or chew formulation.

The edible pet treat or chew formulation may include or be combined with a selected amount of water such that it plasticates better during molding, relative to a formulation that does not include the selected amount of water. In embodiments, the edible pet treat or chew formulation includes or be combined with 1.0% by weight to 20.0% by weight of water, relative to the total weight of the edible pet treat or chew formulation.

The edible pet treat or chew formulation may be extruded to form pellets, which may be subsequently injection molded into a molded product (e.g., an edible pet treat or chew). Alternatively, the edible pet treat or chew formulation may be directly injection molded to form the molded product. In either case, the edible pet treat or chew formulation (optionally including from 1.0% by weight to 20.0% by weight of water) is preferably injection molded in a mold, wherein the mold temperature is set to a temperature ranging from 10° C. to 40° C., more preferably 15° C. to 35° C.

It has been found that when the edible pet treat or chew formulation is injected into a mold during injection molding (directly or following extrusion), the resulting molded product (i.e., molded pet treat or chew) includes a core and an outer layer on the surface of the core, wherein the outer layer has a first characteristic, the core has a second characteristic corresponding to the first characteristic, and the first characteristic differs from the second characteristic. For example, in embodiments the first characteristic (of the outer layer) is color, the second characteristic (of the core) is color, but the first characteristic (color) differs from the second characteristic (color). In such instances the color of the outer layer is different than the color of the core.

The outer layer of the molded product in those and other embodiments may have any suitable thickness. For example, the outer layer may have a thickness in the range of 0.001″ to 0.040″, more preferably in the range of 0.008″ to 0.020″. Without being bound by any particular theory, it is contemplated that the vegetable powder herein, upon contact with the mold surface and oxygen, undergoes a thermal response and a color change, so that the surface of the demolded product has an outer layer on the surface of a core, wherein the outer layer has a different physical appearance than the core. Notably, development of the outer layer and the different in physical properties occurs during a single injection molding cycle.

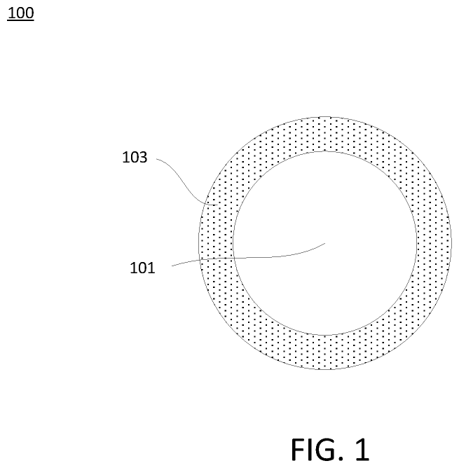

FIG. 1 illustrates one example of a molded product (e.g., a molded pet treat or chew consistent with the present disclosure. Molded product 100 includes a core 101 and an outer layer 103 disposed on the core. In embodiments, outer layer 103 includes the vegetable component of the edible pet treat or chew formulation that was used to form molded product 100, where the outer layer 103 has a different characteristic, such as a different color. The core 101 may be formed from the mixture of edible components with the vegetable component of the edible pet treat or chew formulation. As discussed above, the outer layer 103 may have a first characteristic that corresponds to a second characteristic of the core, wherein the first and second characteristics differ from one another. For example, as noted, in some instances the outer layer 103 is a first color, the core 101 is a second color, and the first and second colors differ from one another. It is noted that while FIG. 1 depicts molded product 100 as having a generally spherical cross section, the compositions, molded products, and methods described herein are not limited to the illustrated shape. Indeed, the compositions and methods described herein may be used to form molded products (e.g., molded pet treats or chews) having any suitable shape, such as but not limited to shapes having a circular, ellipsoidal, oval, triangular, quadrilateral pentagonal, hexagonal, etc., or irregular cross section.

Accordingly, one now can readily identify an edible pet treat or chew formulation that, upon a single injection molding cycle, provides a molded pet treat or chew that includes a core and a surface layer, wherein the surface layer has at least one surface characteristic (e.g. color) that is different from a corresponding characteristic (e.g., color) of the core. As such one can now, e.g., in a single injection molding cycle, produce a pet chew such as an edible bone, where the exterior surface has a first color (e.g., a natural brown color) and the interior has a second color (e.g., a natural red type coloration, representative of a meat type filling).

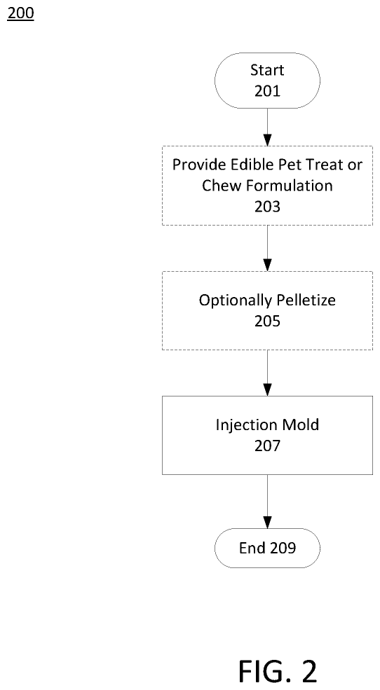

Another aspect of the present disclosure relates to methods of forming molded articles, such as methods of forming molded pet treats or chews. In that regard reference is made to FIG. 2, which is a flow chart of example operations of one example of a method of forming a molded article (e.g., pet treat or chew) consistent with the present disclosure. As shown, method 200 begins at block 201. The method may then proceed to optional block 201, pursuant to which an edible pet treat or chew formulation may be provided. When executed, the operations of optional block 201 may include mixing a vegetable component with one or more edible components, to form an edible pet treat or chew formulation having the above described composition. Alternatively, the operations of block 203 may be omitted, e.g., in instances where an edible pet treat or chew formulation is obtained through some other means, e.g., from a third party.

Following the operations of block 203 (or when block 203 is omitted) the method may proceed to optional block 205, pursuant to which the edible pet treat or chew formulation may be pelletized. In that regard, any suitable process may be used to produce pellets and/or granules of the edible pet treat or chew formulation with a desired size and geometry. Without limitation, in embodiments the operations of block 205 include extruding an edible pet treat or chew formulation in an extruder to form an extrudate, wherein the extrudate is in the form of or is subsequently processed (e.g., via cutting) into pellets/granules. As will be understood by those of skill in the art, the size and shape of the pellets/granules may be controlled in several ways, such as by the appropriate selection and/or configuration of an extrusion head. Prior to extrusion, the edible pet treat or chew formulation may include or be combined with water to facilitate plastication as noted above.

Following the operations of block 205 (or when block 205 is omitted) the method may proceed to block 207, pursuant to which the edible pet treat or chew formulation (or pellets/granules thereof) is injection molded to form a molded article, such as a molded pet treat or chew. In embodiments, operations pursuant to block 207 may be or include injecting the edible pet treat or chew formulation into a mold, wherein the mold temperature is set to a temperature ranging from 10° C. to 40° C., more preferably 15° C. to 35° C. The resulting molded article may have an outer layer on a core, wherein the outer layer has at least one characteristic that differs from a corresponding characteristic of the core, as described above. Notably, the edible pet treat or chew formulation is subject to only a single injection molding cycle to block 207. Following the operations of block 207, the method may proceed to block 209 and end.

The present disclosure therefore broadly relates to a composition and process comprising the steps of: (1) providing an edible based formulation containing 0.1% by weight to 10.0% by weight of a powder vegetable component; (2) introducing said edible based formulation into an injection molding machine and injection molding one or a plurality of edible pet products having a surface layer and a core, wherein during molding of said edible pet product, the surface layer of the pet product develops a physical, optical, nutritional, sensual or compositional property that is different from the core region. Accordingly, one may now form edible pet products that provide a very natural appearance, such as a pet bone having an outer surface typical of natural bone color and an interior color typical of a meat type filling or bone marrow. Remarkably, such product can now be produced in a single injection molding cycle, without having to separately treat the surface or separately mold onto the surface, a different edible composition.

The following examples are additional embodiments of the present disclosure.

### EXAMPLES

### Example 1

According to this example there is provided an edible pet treat or chew formulation, including a mixture of: a vegetable component; and one or more edible components, the one or more edible components including starch; wherein: the edible pet treat or chew formulation, when subject to a single injection molding cycle, forms a molded product including a core and an outer layer on the core, the outer layer having a first characteristic that differs from a corresponding second characteristic of the core.

### Example 2

This example includes any or all of the features of example 1, wherein: the vegetable component includes a vegetable powder (e.g., beet powder) and is present in an amount ranging from 0.1% to 15.0% by weight, relative to the total weight of the edible pet treat or chew formulation; and the starch is present in an amount greater than or equal to 50% by weight of the edible pet treat or chew formulation.

### Example 3

This example includes any or all of the features of example 2, wherein: the vegetable component is present in an amount ranging from 0.1 to 10% by weight, relative to the total weight of the edible pet treat or chew formulation; and the starch is present in an amount ranging from 50 to 75% by weight, relative to the total weight of the edible pet treat or chew formulation.

### Example 4

This example includes any or all of the features of example 3, wherein: the vegetable component comprises beet (e.g., beet powder) and is present in an amount ranging from 3 to 5% by weight, relative to the total weight of the edible pet treat or chew formulation; and the starch is present in an amount ranging from 50 to 60% by weight, relative to the total weight of the edible pet treat or chew formulation.

### Example 5

This example includes any or all of the features of any one of examples 2 to 4, wherein the first characteristic is a first color, the second characteristic is a second color that differs from the first color.

### Example 6

This example includes any or all of the features of any one of examples 2 to 5, further including one or more additives selected from the group consisting of: glycerin in an amount ranging from 10.0 to 20.0% by weight relative to the total weight of the edible pet treat or chew formulation; gelatin in an amount ranging from 5.0% to 15.0% by weight relative to the total weight of the edible pet treat or chew formulation; a palatability enhancer in an amount ranging from 1.0% by weight to 10.0% by weight relative to the total weight of the edible pet treat or chew formulation; calcium carbonate in an amount ranging from 1.0% by weight to 5.0% by weight relative to the total weight of the edible pet treat or chew formulation; cellulose fiber in an amount ranging from 1.0% by weight to 5.0% by weight relative to the total weight of the edible pet treat or chew formulation; and lecithin powder in an amount ranging from 0.1% by weight to 2.5% by weight relative to the total weight of the edible pet treat or chew formulation.

### Example 7

This example includes any or all of the features of example 6, wherein the one or more additives comprise: glycerin in an amount ranging from 10.0 to 20.0% by weight relative to the total weight of the edible pet treat or chew formulation; gelatin in an amount ranging from 5.0% to 15.0% by weight relative to the total weight of the edible pet treat or chew formulation; a palatability enhancer in an amount ranging from 1.0% by weight to 10.0% by weight relative to the total weight of the edible pet treat or chew formulation; calcium carbonate in an amount ranging from 1.0% by weight to 5.0% by weight relative to the total weight of the edible pet treat or chew formulation; cellulose fiber in an amount ranging from 1.0% by weight to 5.0% by weight relative to the total weight of the edible pet treat or chew formulation; and lecithin powder in an amount ranging from 0.1% by weight to 2.5% by weight relative to the total weight of the edible pet treat or chew formulation.

### Example 8

According to this example there is provided a method, including: subjecting an edible pet treat or chew formulation to a single injection molding cycle to form a molded product; wherein: the edible pet treat or chew formulation includes a vegetable component and one or more edible components, the one or more edible components including starch; subjecting the edible pet treat or chew formulation to a single injection molding cycle includes injecting the edible pet treat or chew formulation into a mold, wherein the mold is set to a temperature ranging from 10° C. to 40° C.; and the molded product includes a core and an outer layer on the core, the outer layer having a first characteristic that differs from a corresponding second characteristic of the core.

### Example 9

This example includes any or all of the features of example 8, wherein subjecting the edible pet treat or chew formulation to a single injection molding cycle includes injecting the edible pet treat or chew formulation into a mold, wherein the mold is set to a temperature ranging from 15° C. to 35° C.

### Example 10

This example includes any or all of the features of example 8, wherein: the vegetable component includes a vegetable powder (e.g., beet powder) and is present in an amount ranging from 0.1% to 15.0% by weight, relative to the total weight of the edible pet treat or chew formulation; and the starch is present in an amount greater than or equal to 50% by weight of the edible pet treat or chew formulation.

### Example 11

This example includes any or all of the features of example 8, wherein: the vegetable component is present in an amount ranging from 0.1 to 10% by weight, relative to the total weight of the edible pet treat or chew formulation; and the starch is present in an amount ranging from 50 to 75% by weight, relative to the total weight of the edible pet treat or chew formulation.

### Example 12

This example includes any or all of the features of example 8, wherein: the vegetable component comprises beet (e.g., beet powder) and is present in an amount ranging from 3 to 5% by weight, relative to the total weight of the edible pet treat or chew formulation; and the starch is present in an amount ranging from 50 to 60% by weight, relative to the total weight of the edible pet treat or chew formulation.

### Example 13

This example includes any or all of the features of any one of examples 8 to 12, wherein the first characteristic is a first color, the second characteristic is a second color that differs from the first color.

### Example 14

This example includes any or all of the features of any one of examples 8 to 13, wherein the edible pet treat or chew formulation further includes one or more additives selected from the group consisting of: glycerin in an amount ranging from 10.0 to 20.0% by weight relative to the total weight of the edible pet treat or chew formulation; gelatin in an amount ranging from 5.0% to 15.0% by weight relative to the total weight of the edible pet treat or chew formulation; a palatability enhancer in an amount ranging from 1.0% by weight to 10.0% by weight relative to the total weight of the edible pet treat or chew formulation; calcium carbonate in an amount ranging from 1.0% by weight to 5.0% by weight relative to the total weight of the edible pet treat or chew formulation; cellulose fiber in an amount ranging from 1.0% by weight to 5.0% by weight relative to the total weight of the edible pet treat or chew formulation; and lecithin powder in an amount ranging from 0.1% by weight to 2.5% by weight relative to the total weight of the edible pet treat or chew formulation.

### Example 15

This example includes any or all of the features of example 14, wherein the one or more additives comprise: glycerin in an amount ranging from 10.0 to 20.0% by weight relative to the total weight of the edible pet treat or chew formulation; gelatin in an amount ranging from 5.0% to 15.0% by weight relative to the total weight of the edible pet treat or chew formulation; a palatability enhancer in an amount ranging from 1.0% by weight to 10.0% by weight relative to the total weight of the edible pet treat or chew formulation; calcium carbonate in an amount ranging from 1.0% by weight to 5.0% by weight relative to the total weight of the edible pet treat or chew formulation; cellulose fiber in an amount ranging from 1.0% by weight to 5.0% by weight relative to the total weight of the edible pet treat or chew formulation; and lecithin powder in an amount ranging from 0.1% by weight to 2.5% by weight relative to the total weight of the edible pet treat or chew formulation.

### Example 16

According to this example there is provided a molded pet treat or chew, including: a core; and an outer layer on the core; wherein the molded pet treat or chew includes an edible pet treat or chew formulation that includes a vegetable component and one or more edible components, the one or more edible components including starch; and the outer layer has a first characteristic that differs from a corresponding second characteristic of the core.

### Example 17

This example includes any or all of the features of example 16, wherein: the vegetable component includes a vegetable powder (e.g., beet powder) and is present in an amount ranging from 0.1% to 15.0% by weight, relative to the total weight of the edible pet treat or chew formulation; and the starch is present in an amount greater than or equal to 50% by weight of the edible pet treat or chew formulation.

### Example 18

This example includes any or all of the features of example 17, wherein: the vegetable component is present in an amount ranging from 0.1 to 10% by weight, relative to the total weight of the edible pet treat or chew formulation; and the starch is present in an amount ranging from 50 to 75% by weight, relative to the total weight of the edible pet treat or chew formulation.

### Example 19

This example includes any or all of the features of example 17, wherein: the vegetable component comprises beet (e.g., beet powder) and is present in an amount ranging from 3 to 5% by weight, relative to the total weight of the edible pet treat or chew formulation; and the starch is present in an amount ranging from 50 to 60% by weight, relative to the total weight of the edible pet treat or chew formulation.

### Example 20

This example includes any or all of the features of any one of examples 17 to 19, wherein the first characteristic is a first color, the second characteristic is a second color that differs from the first color.

### Example 21

This example includes any or all of the features of any one of examples 17 to 20, wherein the edible pet treat or chew formulation further includes one or more additives selected from the group consisting of: glycerin in an amount ranging from 10.0 to 20.0% by weight relative to the total weight of the edible pet treat or chew formulation; gelatin in an amount ranging from 5.0% to 15.0% by weight relative to the total weight of the edible pet treat or chew formulation; a palatability enhancer in an amount ranging from 1.0% by weight to 10.0% by weight relative to the total weight of the edible pet treat or chew formulation; calcium carbonate in an amount ranging from 1.0% by weight to 5.0% by weight relative to the total weight of the edible pet treat or chew formulation; cellulose fiber in an amount ranging from 1.0% by weight to 5.0% by weight relative to the total weight of the edible pet treat or chew formulation; and lecithin powder in an amount ranging from 0.1% by weight to 2.5% by weight relative to the total weight of the edible pet treat or chew formulation.

### Example 22

This example includes any or all of the features of example 21, wherein the one or more additives comprise: glycerin in an amount ranging from 10.0 to 20.0% by weight relative to the total weight of the edible pet treat or chew formulation; gelatin in an amount ranging from 5.0% to 15.0% by weight relative to the total weight of the edible pet treat or chew formulation; a palatability enhancer in an amount ranging from 1.0% by weight to 10.0% by weight relative to the total weight of the edible pet treat or chew formulation; calcium carbonate in an amount ranging from 1.0% by weight to 5.0% by weight relative to the total weight of the edible pet treat or chew formulation; cellulose fiber in an amount ranging from 1.0% by weight to 5.0% by weight relative to the total weight of the edible pet treat or chew formulation; and lecithin powder in an amount ranging from 0.1% by weight to 2.5% by weight relative to the total weight of the edible pet treat or chew formulation.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed.

The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary. The terms “first,” “second,” and the like herein do not denote any order, quantity, or importance, but rather are used to distinguish one element from another, and the terms “a” and “an” herein do not denote a limitation of quantity, but rather denote the presence of at least one of the referenced item.

What is claimed is:

1. A method, comprising
subjecting an edible pet treat or chew formulation to a single injection molding cycle to form a molded product; wherein:
the edible pet treat or chew formulation comprises a vegetable component and one or more edible components, the one or more edible components comprising starch;
subjecting the edible pet treat or chew formulation to a single injection molding cycle comprises injecting the edible pet treat or chew formulation into a mold, wherein the mold is set to a temperature ranging from 10° C. to 40° C.; and
the molded product comprises a core and an outer layer on the core, the outer layer having a first characteristic that differs from a corresponding second characteristic of the core.

2. The method of claim 1, wherein subjecting the edible pet treat or chew formulation to a single injection molding cycle comprises injecting the edible pet treat or chew formulation into a mold, wherein the mold is set to a temperature ranging from 15° C. to 35° C.

3. The method of claim 1, wherein:
the vegetable component comprises a vegetable powder and is present in an amount ranging from 0.1% to 15.0% by weight, relative to the total weight of the edible pet treat or chew formulation; and
said starch is present in an amount greater than or equal to 50% by weight of the edible pet treat or chew formulation.

4. The method of claim 1, wherein:
the vegetable component is present in an amount ranging from 0.1 to 10% by weight, relative to the total weight of the edible pet treat or chew formulation; and
said starch is present in an amount ranging from 50 to 75% by weight, relative to the total weight of the edible pet treat or chew formulation.

5. The method of claim 1, wherein:
the vegetable component comprises beet and is present in an amount ranging from 3 to 5% by weight, relative to the total weight of the edible pet treat or chew formulation; and
said starch is present in an amount ranging from 50 to 60% by weight, relative to the total weight of the edible pet treat or chew formulation.

6. The method of claim 1, wherein the first characteristic is a first color, the second characteristic is a second color that differs from the first color.

7. The method of claim 1, wherein the edible pet treat or chew formulation further comprises one or more additives selected from the group consisting of:
glycerin in an amount ranging from 10.0 to 20.0% by weight relative to the total weight of the edible pet treat or chew formulation;
gelatin in an amount ranging from 5.0% to 15.0% by weight relative to the total weight of the edible pet treat or chew formulation;
a palatability enhancer in an amount ranging from 1.0% by weight to 10.0% by weight relative to the total weight of the edible pet treat or chew formulation;
calcium carbonate in an amount ranging from 1.0% by weight to 5.0% by weight relative to the total weight of the edible pet treat or chew formulation;
cellulose fiber in an amount ranging from 1.0% by weight to 5.0% by weight relative to the total weight of the edible pet treat or chew formulation; and
lecithin powder in an amount ranging from 0.1% by weight to 2.5% by weight relative to the total weight of the edible pet treat or chew formulation.

8. The method of claim 1, wherein the one or more additives comprise:
glycerin in an amount ranging from 10.0 to 20.0% by weight relative to the total weight of the edible pet treat or chew formulation;
gelatin in an amount ranging from 5.0% to 15.0% by weight relative to the total weight of the edible pet treat or chew formulation;
a palatability enhancer in an amount ranging from 1.0% by weight to 10.0% by weight relative to the total weight of the edible pet treat or chew formulation;
calcium carbonate in an amount ranging from 1.0% by weight to 5.0% by weight relative to the total weight of the edible pet treat or chew formulation;
cellulose fiber in an amount ranging from 1.0% by weight to 5.0% by weight relative to the total weight of the edible pet treat or chew formulation; and
lecithin powder in an amount ranging from 0.1% by weight to 2.5% by weight relative to the total weight of the edible pet treat or chew formulation.

9. A edible pet treat or chew formulation, comprising a mixture of:
a vegetable component; and
one or more edible components, the one or more edible components comprising starch; wherein:
the edible pet treat or chew formulation, when subject to a single injection molding cycle, forms a molded product comprising a core and an outer layer on the core, the outer layer having a first characteristic that differs from a corresponding second characteristic of the core.

10. The edible pet treat or chew formulation of claim 9, wherein:
the vegetable component comprises a vegetable powder and is present in an amount ranging from 0.1% to 15.0% by weight, relative to the total weight of the edible pet treat or chew formulation; and
said starch is present in an amount greater than or equal to 50% by weight of the edible pet treat or chew formulation.

11. The edible pet treat or chew formulation of claim 10, wherein:
the vegetable component is present in an amount ranging from 0.1 to 10% by weight, relative to the total weight of the edible pet treat or chew formulation; and
said starch is present in an amount ranging from 50 to 75% by weight, relative to the total weight of the edible pet treat or chew formulation.

12. The edible pet treat or chew formulation of claim 11, wherein:
the vegetable component comprises beet and is present in an amount ranging from 3 to 5% by weight, relative to the total weight of the edible pet treat or chew formulation; and
said starch is present in an amount ranging from 50 to 60% by weight, relative to the total weight of the edible pet treat or chew formulation.

13. The edible pet treat or chew formulation of claim 10, wherein the first characteristic is a first color, the second characteristic is a second color that differs from the first color.

14. The edible pet treat or chew formulation of claim 10, further comprising one or more additives selected from the group consisting of:
glycerin in an amount ranging from 10.0 to 20.0% by weight relative to the total weight of the edible pet treat or chew formulation;
gelatin in an amount ranging from 5.0% to 15.0% by weight relative to the total weight of the edible pet treat or chew formulation;
a palatability enhancer in an amount ranging from 1.0% by weight to 10.0% by weight relative to the total weight of the edible pet treat or chew formulation;
calcium carbonate in an amount ranging from 1.0% by weight to 5.0% by weight relative to the total weight of the edible pet treat or chew formulation;
cellulose fiber in an amount ranging from 1.0% by weight to 5.0% by weight relative to the total weight of the edible pet treat or chew formulation; and
lecithin powder in an amount ranging from 0.1% by weight to 2.5% by weight relative to the total weight of the edible pet treat or chew formulation.

15. The edible pet treat or chew formulation of claim 14, wherein the one or more additives comprise:
glycerin in an amount ranging from 10.0 to 20.0% by weight relative to the total weight of the edible pet treat or chew formulation;
gelatin in an amount ranging from 5.0% to 15.0% by weight relative to the total weight of the edible pet treat or chew formulation;
a palatability enhancer in an amount ranging from 1.0% by weight to 10.0% by weight relative to the total weight of the edible pet treat or chew formulation;
calcium carbonate in an amount ranging from 1.0% by weight to 5.0% by weight relative to the total weight of the edible pet treat or chew formulation;
cellulose fiber in an amount ranging from 1.0% by weight to 5.0% by weight relative to the total weight of the edible pet treat or chew formulation; and
lecithin powder in an amount ranging from 0.1% by weight to 2.5% by weight relative to the total weight of the edible pet treat or chew formulation.

16. A molded pet treat or chew, comprising:
a core; and
an outer layer on the core; wherein
the molded pet treat or chew comprises an edible pet treat or chew formulation that comprises a vegetable component and one or more edible components, the one or more edible components comprising starch; and
the outer layer has a first characteristic that differs from a corresponding second characteristic of the core.

17. The molded pet treat or chew of claim 16, wherein:
the vegetable component comprises a vegetable powder and is present in an amount ranging from 0.1% to 15.0% by weight, relative to the total weight of the edible pet treat or chew formulation; and
said starch is present in an amount greater than or equal to 50% by weight of the edible pet treat or chew formulation.

18. The molded pet treat or chew of claim 17, wherein:
the vegetable component is present in an amount ranging from 0.1 to 10% by weight, relative to the total weight of the edible pet treat or chew formulation; and
said starch is present in an amount ranging from 50 to 75% by weight, relative to the total weight of the edible pet treat or chew formulation.

19. The molded pet treat or chew of claim 17, wherein:
the vegetable component comprises beet and is present in an amount ranging from 3 to 5% by weight, relative to the total weight of the edible pet treat or chew formulation; and
said starch is present in an amount ranging from 50 to 60% by weight, relative to the total weight of the edible pet treat or chew formulation.

20. The molded pet treat or chew of claim 17, wherein the first characteristic is a first color, the second characteristic is a second color that differs from the first color.

21. The molded pet treat or chew of claim 17, wherein the edible pet treat or chew formulation further comprises one or more additives selected from the group consisting of:
glycerin in an amount ranging from 10.0 to 20.0% by weight relative to the total weight of the edible pet treat or chew formulation;
gelatin in an amount ranging from 5.0% to 15.0% by weight relative to the total weight of the edible pet treat or chew formulation;
a palatability enhancer in an amount ranging from 1.0% by weight to 10.0% by weight relative to the total weight of the edible pet treat or chew formulation;
calcium carbonate in an amount ranging from 1.0% by weight to 5.0% by weight relative to the total weight of the edible pet treat or chew formulation;
cellulose fiber in an amount ranging from 1.0% by weight to 5.0% by weight relative to the total weight of the edible pet treat or chew formulation; and
lecithin powder in an amount ranging from 0.1% by weight to 2.5% by weight relative to the total weight of the edible pet treat or chew formulation.

22. The edible pet treat or chew formulation of claim 21, wherein the one or more additives comprise:
glycerin in an amount ranging from 10.0 to 20.0% by weight relative to the total weight of the edible pet treat or chew formulation;
gelatin in an amount ranging from 5.0% to 15.0% by weight relative to the total weight of the edible pet treat or chew formulation;
a palatability enhancer in an amount ranging from 1.0% by weight to 10.0% by weight relative to the total weight of the edible pet treat or chew formulation;
calcium carbonate in an amount ranging from 1.0% by weight to 5.0% by weight relative to the total weight of the edible pet treat or chew formulation;
cellulose fiber in an amount ranging from 1.0% by weight to 5.0% by weight relative to the total weight of the edible pet treat or chew formulation; and
lecithin powder in an amount ranging from 0.1% by weight to 2.5% by weight relative to the total weight of the edible pet treat or chew formulation.
